(19) United States
(12) Patent Application Publication
(10) Pub. No.: US 2016/0320508 A1
(43) Pub. Date: Nov. 3, 2016

(54) DEVICES AND METHODS FOR ATTENUATION OF TURN NOISE IN SEISMIC DATA ACQUISITION

(71) Applicant: CGG SERVICES SA, Massy (FR)

(72) Inventor: Can PENG, Fulshear, TX (US)

(21) Appl. No.: 15/105,783

(22) PCT Filed: Jan. 12, 2015
(86) PCT No.: PCT/IB2015/000788

§ 371 Date: Jun. 17, 2016

Related U.S. Application Data
(60) Provisional application No. 61/926,668, filed on Jan. 13, 2014.

(51) Int. Cl. G01V 1/36; G01V 1/38; G01V 1/32

(52) U.S. Cl. CPC G01V 1/364; G01V 1/32; G01V 1/38; G01V 2210/47; G01V 2210/244; G01V 2210/324

(57) ABSTRACT

Computing device, computer instructions and method for de-noising seismic data recorded with seismic receivers. The method includes transforming the seismic data into a Tau-P domain to generate transformed seismic data traces. The transformed seismic data traces are scaled using a semblance value to generate scaled seismic data traces. A scaled seismic data trace having a maximum energy; is selected and removed from the seismic data to generate de-noised seismic data.

### CROSS REFERENCE TO RELATED APPLICATION

The present application is related to, and claims the benefit of priority, of U.S. Provisional Application Serial No. 61/926,668, having the title “Coherence-Preferred Anti-Leakage TauP Transform For Noise Attenuation” to Can Peng, filed Jan. 13, 2014, the entire content of which is incorporated herein by reference.

### BACKGROUND

1. Technical Field

Embodiments of the subject matter disclosed herein generally relate to methods and systems for removing noise from seismic data.

2. Discussionof the Background

Marine seismic data acquisition and processing generates a profile (image) of the geophysical structure under the seafloor. While this profile does not necessarily pinpoint location(s) for oil and gas reservoirs, it suggests, to those trained in the field, the presence or absence of them. Thus, providing a high-resolution image of the subsurface is an ongoing concern to those engaged in seismic data acquisition.

Generally, a seismic source is used to generate a seismic signal which propagates into the earth, and it is at least partially reflected by various seismic reflectors in the subsurface. The reflected waves are recorded by seismic receivers. The seismic receivers may be located on the ocean bottom, close to the ocean bottom, below a surface of the water, at the surface of the water, on the surface of the earth, or in boreholes in the earth. When towed by a vessel, the seismic receivers can be attached to streamers and, to image a desired subsurface region, the vessel will need to make numerous turns to pass back and forth through the targeted cell. The recorded seismic datasets, e.g., travel-time, may be processed to yield information relating to the location of the subsurface reflectors and the physical properties of the subsurface formations, e.g., to generate an image of the subsurface.

Many land and ocean bottom datasets suffer from high levels of noise, which make the task of processing and interpretation difficult. Accordingly one or more noise attenuation processes are typically employed as one of the data processing techniques used to generate images of the subsurface. These noise attenuation methods can include, for example, F-X prediction filtering (see, e.g., Canales, L. L., “Random noise reduction,” 54^{th} SEG Annual International Meeting, Expanded Abstracts, 3, no. 1, 525-529, 1984), projection filtering (see, e.g., Soubaras, R., “Signal-preserving random noise attenuation by the F-X projection,” 64^{th} SEG Annual International Meeting, Expanded Abstracts, 13, no. 1, 1576-1579, 1994), SVD rank-reduction methods (see, e.g., Sacchi, M., “FX singular spectrum analysis”, CSPG CSEG CWLS Convention, 2009), and anti-leakage Fourier transforms. However, in marine seismic data for example, the strong noise caused by vessel turning is frequently clustered in both the channel and shot domains. Statistically, this noise is non-Gaussian in distribution and can be challenging for such conventional noise attenuation procedures to remove since most noise attenuation methods rely on the assumption of Gaussian-distributed noise and the predictability of coherent signals.

For erratic noise patterns, robust versions of the rank-reduction method have been proposed (see, e.g., Chen, K., and M. Sacchi, “Robust Reduced-Rank Seismic Denoising”, 83rd Annual International Meeting, SEG, Expanded Abstracts, pp. 4272-4277, 2013), in which data points that contain the strong erratic noise are treated as outliers in the processing window. These outliers are then assigned a small weight to make them less significant in the data fitting. Unfortunately, the turn noise patterns in acquired seismic data are typically clustered such that the noisy data points do not display as outliers, and therefore can leak into the predicted signals, making this noise attenuation processing also sub-optimal for removal of turn noise.

Another de-noising technique, referred to herein as a conventional anti-leakage Tau-P transform, has been proposed (and is discussed in more detail below). However this technique suffers from the problem that energy from a strong noise burst, such as that created by vessel turns, is not adequately removed.

Accordingly, there is a need in the industry to find a method for de-noising this type of data.

### SUMMARY

According to an exemplary embodiment, computing devices, computer instructions and methods for de-noising seismic data recorded with seismic receivers are described which, for example, avoids blindly fitting strong yet incoherent noise patterns with low semblance.

According to an embodiment, a method includes transforming the seismic data into a Tau-P domain to generate transformed seismic data traces. The transformed seismic data traces are scaled using a semblance value to generate scaled seismic data traces. A scaled seismic data trace having a maximum energy; is selected and removed from the seismic data to generate de-noised seismic data.

According to another embodiment, a computing device for de-noising seismic data recorded with seismic receivers includes an interface configured to receive the seismic data recorded with the seismic receivers, wherein the seismic data is recorded in a time-space domain. A processor connected to the interface is configured to implement a de-noising technique including: transforming the seismic data from the time-space domain into a Tau-P domain to generate transformed seismic data traces; scaling the transformed seismic data traces using a semblance value to generate scaled seismic data traces; selecting a scaled seismic data trace having a maximum energy; and removing the selected, scaled seismic data trace from the seismic data to generate de-noised seismic data.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a flowchart of an algorithm for de-noising seismic data according to a conventional anti-leakage Tau-P transform technique;

FIG. 2 is a schematic diagram of a seismic survey system;

FIG. 3 is a flowchart of an algorithm for de-noising seismic data according to an embodiment of a coherence anti-leakage Tau-P transform technique;

FIG. 4 is a flowchart depicting a method according to an embodiment;

FIG. 5 is a schematic diagram of a computing device for de-noising data according to an embodiment;

FIGS. 6(a)-6(g) illustrate seismic data undergoing de-noising according to both a conventional technique and a coherence anti-leakage Tau-P transform technique according to an embodiment; and

FIG. 7 depicts spectra associated with de-noising according to an embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to seismic data that is de-noised based on an anti-leakage, Tau-P transform to attenuate, among other types of noise, turn noise.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a noise attenuation process which uses a modified anti-leakage Tau-P transform to attenuate turn noise is described. This modified version of the anti-leakage Tau-P transform fits the signal energy from the seismic data while considering its coherence, and avoids fitting the strong, erratic turn noise from the seismic data. Although described herein by way of its applicability to remove turn noise from marine seismic acquisitions, the present invention is not limited thereto and can be used to remove any similar sort of noise in land or marine seismic applications, e.g., spiky noise or energy associated with other sources in a deblending context.

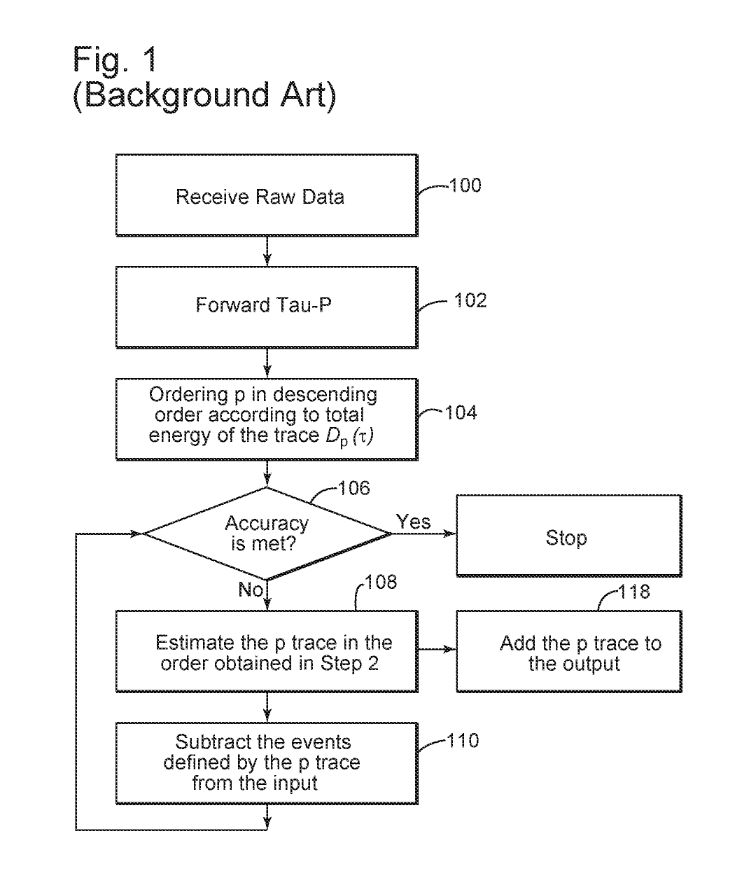

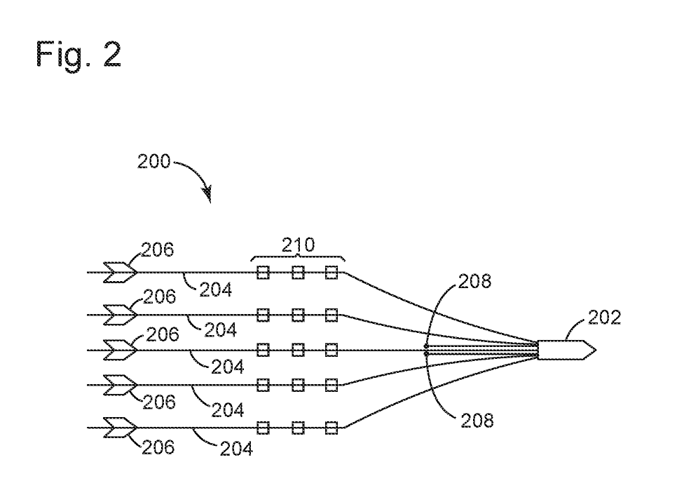

FIG. 1 depicts a conventional method for de-noising seismic data using a so-called anti-leakage Tau-P transform described by G. Poole in the article “Multi-Dimensional Coherency Driven De-noising of Irregular Data, published in the 73^{1d} EAGE Conference and Exhibition, 2011. Therein, raw seismic data is received in step 100. In this context “raw” seismic data simply refers to data that has not yet had this de-noising technique applied thereto, but not necessarily data which is completely unprocessed since (as will be appreciated by those skilled in the art) raw seismic data undergoes many different processing techniques prior to being rendered into an image of the subsurface and de-noising according to these embodiments may be performed before or after various ones of those other techniques. The raw seismic data can be recorded with a land or marine receiver. The receiver may be any one of a geophone, hydrophone, accelerometer or a combination of these elements. A purely illustrative marine seismic system 200 for recording seismic waves (data) that includes a plurality of receivers is shown in FIG. 2.

In FIG. 2, a seismic data acquisition system 200 includes a ship 202 towing a plurality of streamers 204 that can extend one or more kilometers behind the ship 202. Each of the streamers 204 can include one or more birds 206 that maintain the streamers 204 in a known (potentially fixed) position relative to other streamers 204, and the one or more birds 206 are capable of moving the streamers 204 as desired according to bi-directional communications received by the birds 206 from the ship 202 both horizontally and vertically (depthwise) to maintain a desired depth profile of each streamer as well as their desired relative separation.

One or more source arrays 208 can also be towed by ship 202, or another ship (not shown), for generating seismic waves. The source arrays 208 can include an impulsive source (e.g., an air gun), a continuous source (e.g., a marine vibrator) or both. Source arrays 208 can be placed either in front of or behind the receivers 210, or both behind and in front of the receivers 210. The seismic waves generated by the source arrays 208 propagate downward, reflect off of, and penetrate the seafloor, wherein the refracted waves eventually are reflected by one or more reflecting structures (not shown in FIG. 1) back toward the surface. The reflected seismic waves then propagate upward and are detected by the receivers 210 disposed on the streamers 204, which seismic waves are converted into raw seismic data by the one or more transducers in the receivers 210 for storage and subsequent processing as described herein. It is noted that the seismic raw data is recorded in the x-t domain.

Returning to FIG. 1, the computing device (to be discussed later) uses the raw seismic data received in step 100 to transform it in step 102 into a slant stack domain, i.e., by performing a forward Tau-P transform thereon in a manner which will be known to those skilled in the art. For example, the transform that is applied to the seismic raw data may be a Radon transform. However, if the de-noising technique according to these embodiments is desired to be amplitude-preserving and to model the energy beyond aliasing, then a high resolution Radon transform should be applied at step 102 (see, e.g., Herrmann et al., “De-aliased, high-resolution Radon transforms,” 70^{th} SEG Annual International Meeting, Expanded Abstracts, 1953-1956, 2000) or a slant stack equivalent of the anti-leakage Fourier transform (see Xu et al., “Anti-leakage Fourier transform for seismic data regularization,” Geophysics, 70, 87-95, 2005, and Ng and Perz, “High resolution Radon transform in the t-x domain using Intelligent' prioritization of the Gauss-Seidel estimation sequence,” 74^{th} SEG Annual International Meeting, Expanded Abstracts, 2004).

A high-resolution Radon transform is also known as a tau-p transform, where tau is the time-intercept and p is the slowness. There are variations of the tau-p transform that include linear, parabolic, hyperbolic, shifted hyperbolic, etc. The tau-p transform may be solved either in the time- or frequency-domain in a mixture of dimensions, for example tau-pₓ-p_{y}-qₕ, where p relates to linear, q relates to parabolic and x, y, and h refer to the x-, y-, and offset-directions, respectively. The Tau-P transform of a trace p can be calculated as:

D(p,τ)=∫d(x, τ−p*x)dx (1)

or equivalently

D(p, τ)=Σᵢ d(xᵢ, τ−92 *xᵢ) (2)

The next step 104 of the conventional anti-leakage Tau-P transform involves ranking or ordering the p traces which are the result of the Tau-P transform in descending order according to their total energy. A loop including steps 106, 108 and 110 then operates on the ordered list of p generated at step 104 until an accuracy criterion is met at step 106. The accuracy criterion can, for example, be a ratio of the residual energy to the total input energy, e.g. 1% or 0.1%. More specifically, until the accuracy criterion is met at step 106, the next p trace in the list, i.e., the p trace with the highest energy, is selected at step 108 for subtraction from the input data at step 110. That is, the p trace with the highest energy is removed from the seismic data set (and saved in another output file at step 112). Then, the input is tested against the accuracy criterion again in step 106, and the process iterates until completion.

However, the conventional anti-leakage Tau-P transform described above with respect to FIG. 1 suffers from the problem that energy from a strong noise burst will leak into almost every p trace such that this conventional technique will typically still result in a considerable amount of noise energy being present in its output when, for example, turn noise is present in the raw seismic data.

This problem is addressed by the embodiments, which describe a coherence-preferred anti-leakage Tau-P transform and which differ from the conventional Tau-P transform in, for example, the way that the optimal p trace is selected for removal in each iteration. Instead of directly using the energy of the slant-stacking trace to choose the optimal p for removal, embodiments first use a power of the semblance at each r along a p to scale the slant-stacking trace at that p. Then the embodiments use the energy of the semblance-scaled p trace, Si (p, r)T(p, r), to pick the optimal p, where T(p, r) is the slant-stacking trace along p, S(p, r) is the semblance along p at r, and i is the power index. The power index is used, according to an embodiment, to tune the significance of the coherence; i.e., the larger the power index value, the more significant the coherence is in the process.

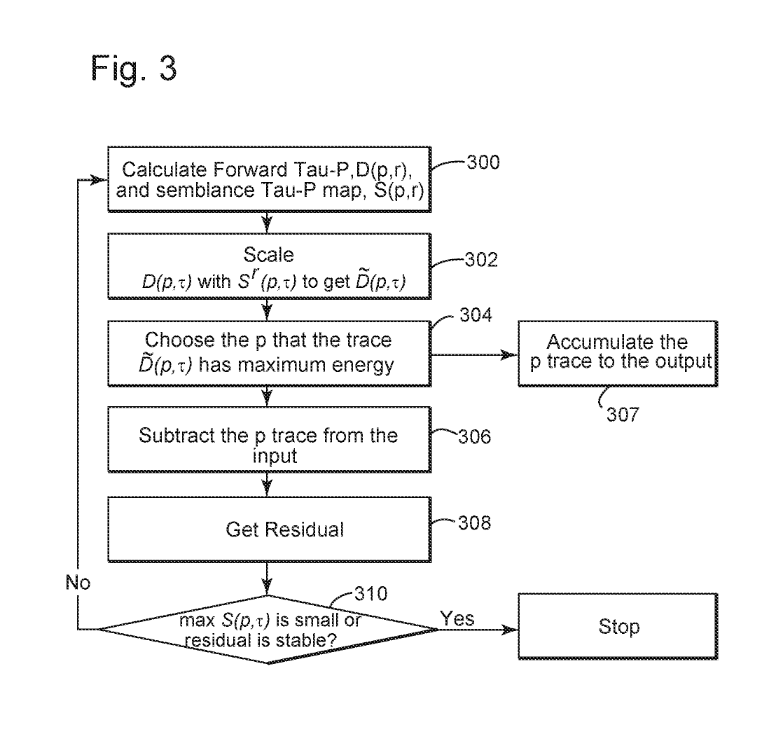

To illustrate such embodiments, an example is provided in FIG. 3. Therein, at step 300, the traces are transformed into the Tau-P domain and a semblance Tau-P map is calculated for each trace, e.g., as:

$$s ( ρ , τ ) = \frac{{\sum }_{i = 1}^{N} {d ( {x}_{i} , τ - p * {x}_{i} )}^{2}}{N {\sum }_{i = 1}^{N} {d}^{2} ( xi , τ - p * xi )} \qquad ( 3 )$$

Each p trace is then scaled at step 302 by multiplying it with the semblance Tau-P map which was defined in step 300 to generate a scaled p trace as for example:

\tilde{D}(p, τ)=D(p, τ)×s^{r}(p, τ) (4)

The scaled p trace having the maximum energy is then selected at step 304 and removed from the input at step 306. The larger the power index, the more significant the semblance becomes in the p selection. The selected p trace is also accumulated to an output file at step 307 for later use in the processing of the seismic data. The residual, i.e., the seismic data minus the p trace removed at step 306, is evaluated at step 310 to determine whether the maximum semblance is small or similarly if the residual is stable. When the maximum semblance in the residual is small enough, the residual is very random, and very likely is noise; hence there is no need to continue the process. If either of these criteria is met (although different embodiments may evaluate the residual for only one or the other or both), then the process ends, and if not the process returns for another iteration. Once the stopping criterion is met at step 310, the signal model is obtained in the Tau-P domain and, after reconstruction by performing an inverse Tau-P transform (not shown in FIG. 3), the noise-attenuated data are obtained.

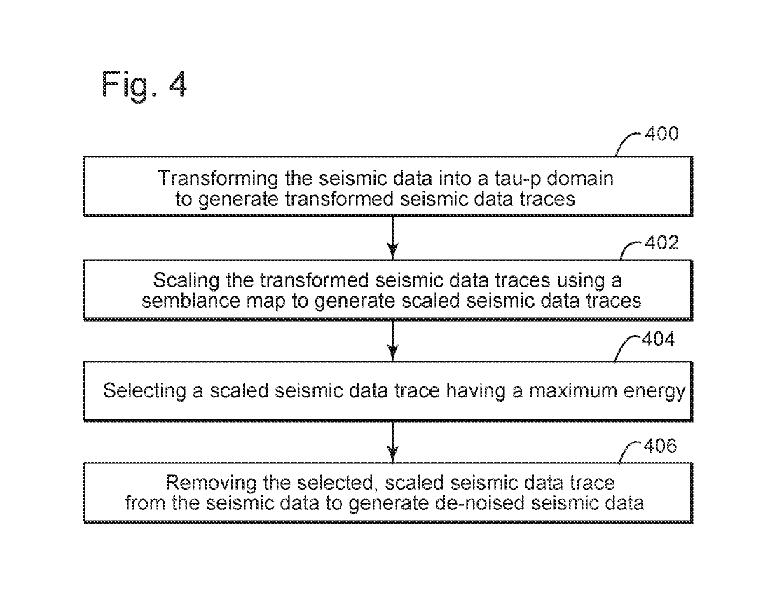

The method embodiments can be expressed in other forms or variants. For example, as shown in FIG. 4, another method for de-noising seismic data is depicted according to another embodiment. Therein, at step 400, the seismic data is transformed into a tau-p domain to generate transformed seismic data traces. The transformed seismic data traces are scaled using a semblance map to generate scaled seismic data traces at step 402. A scaled seismic data trace having a maximum energy is selected at step 404. The selected, scaled seismic data trace is removed from the seismic data at step 406 to generate de-noised seismic data.

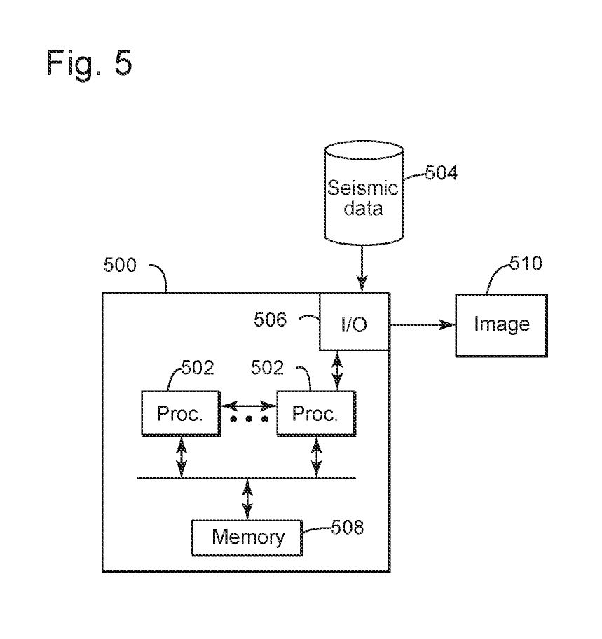

The embodiments can also be expressed in forms other than methods. For example, the seismic data can be processed to, among other things, be de-noised as described above using a computing system which is suitably programmed to perform these de-noising techniques. A generalize example of such a system 500 is provided as FIG. 5. Therein, one or more processors 502 can receive, as input, raw seismic data 504 via input/output device(s) 506. The data can be processed to de-noise the input traces as described above and temporarily stored in the memory device 508. When the seismic data processing is complete, one or more images 510 of the subsurface associated with the seismic data can be generated either as a displayed image on a monitor, a hard copy on a printer or an electronic image stored to a removable memory device.

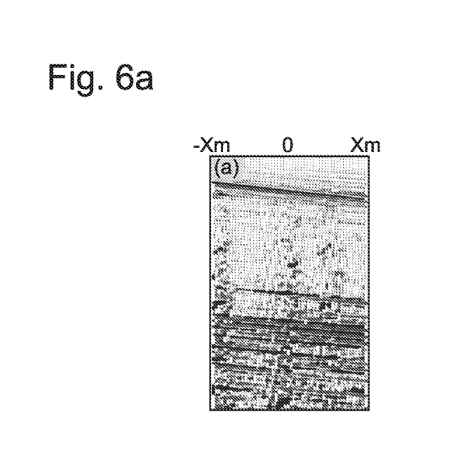

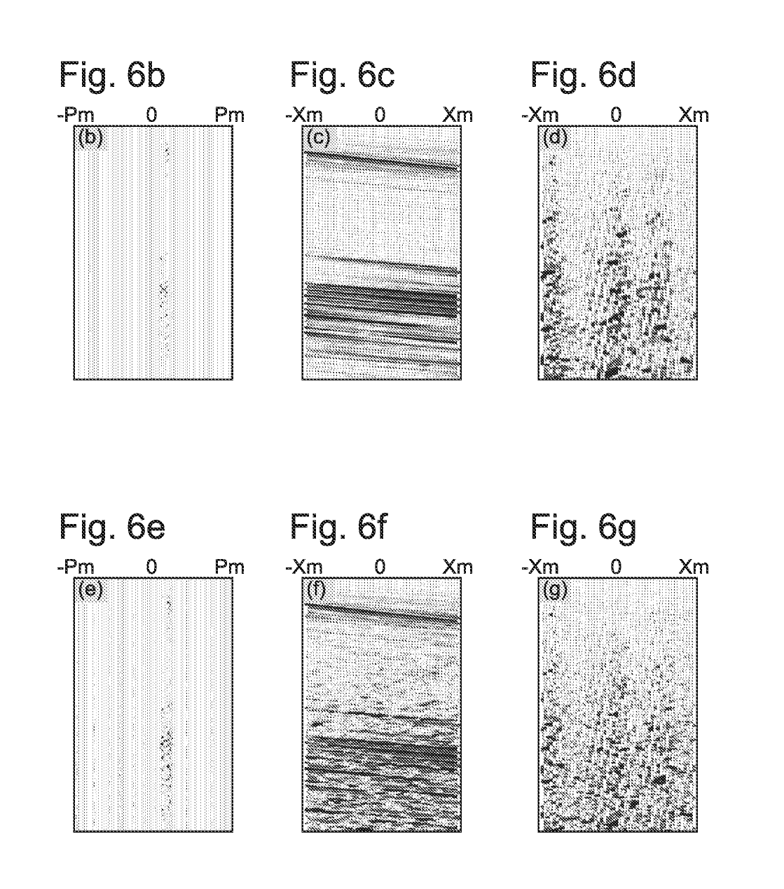

Some of the benefits of the embodiments may be appreciated by comparing outputs generated using the conventional anti-leakage Tau-P de-noising technique, with those generated using techniques in accordance with the embodiments as shown, for example, in FIGS. 6(a)-6(g). Therein, raw seismic data input to the two de-noising techniques is illustrated in FIG. 6(a), which raw seismic data includes strong clustering turn noise. FIGS. 6(b)-6(d) represent the raw seismic data after application of various aspects of the coherence preferred anti-leakage Tau-P transform de-noising techniques according to the embodiments described herein, while FIGS. 6(e)-6(g) represent the corresponding outputs of the raw seismic data after application of the conventional anti-leakage Tau-P transform.

More specifically, FIGS. 6(b) and 6(e) show the raw seismic data from FIG. 6(a) after a de-noising technique like that described in FIG. 3 has been applied (FIG. 6(b)) and after a de-noising technique like that described in FIG. 1 has been applied (FIG. 6(e)). By comparing FIG. 6(b) with FIG. 6(e), it can be observed that the coherence preferred anti-leakage Tau-P transform has a cleaner Tau-P mode output given the same input than that generated by the conventional anti-leakage Tau-P transform. Similarly, comparing FIG. 6(c) (which shows the data from FIG. 6(b) after an inverse Tau-P transform has been applied thereto according to an embodiment) with FIG. 6(f) (which shows the data from FIG. 6(e) after an inverse Tau-P transform has been applied thereto using the conventional processing), it can be seen in this domain that the time domain representation is also cleaner when using techniques according to these embodiments since only a minimal amount of noisy energy has leaked into the reconstructed image of FIG. 6(c). For completeness, FIGS. 6(d) and 6(g) depict the removed noise using the de-noising technique according to an embodiment and the conventional technique, respectively.

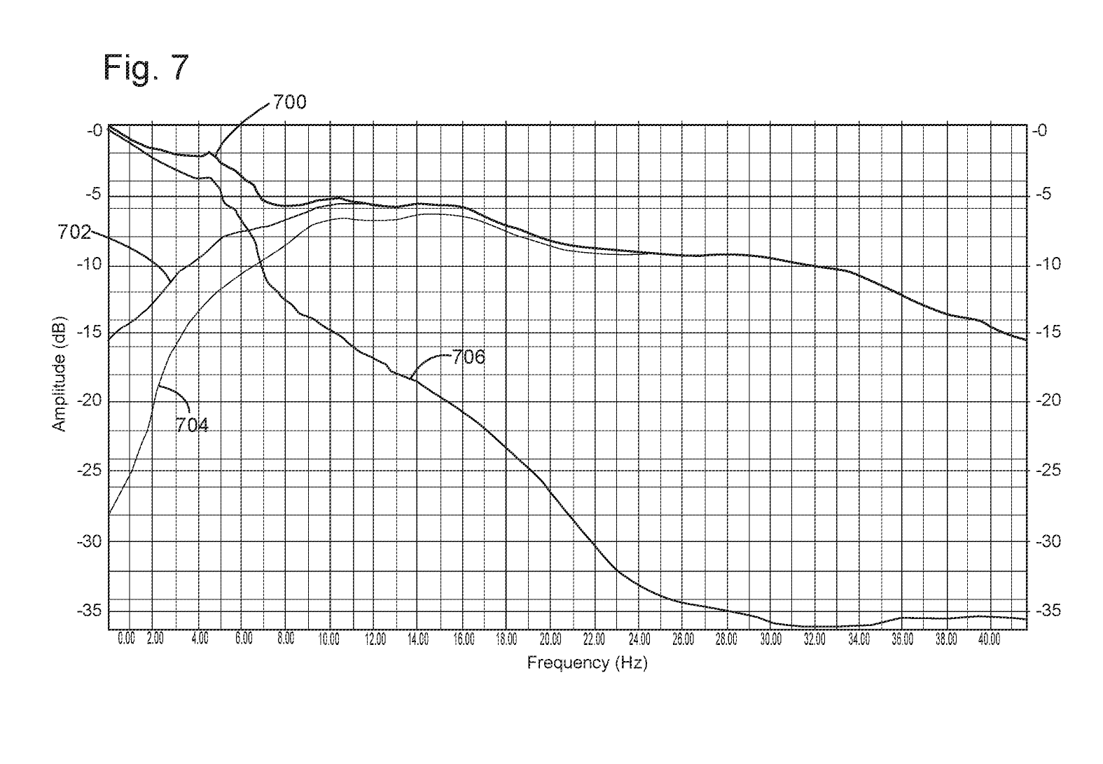

Another way to visualize the benefits of de-noising techniques according to these embodiments, in addition to the seismic trace graphs of FIGS. 6(a)-6(g), is by way of a spectral comparison, i.e., a frequency vs. amplitude plot, of the various input and output functions, an example of which is provided as FIG. 7. Therein, function 700 represents the raw, input seismic data. Function 702 represents the output after a conventional F-K (dip) filtering is applied to the input data 700 to remove noise, while function 704 represents the output after a coherence-preferred anti-leakage Tau-P de-noising technique according to the embodiments is applied to the input data 700. Function 706 indicates the total noise removed by applying a coherence-preferred anti-leakage Tau-P de-noising technique according to these embodiments, i.e., the difference between function 700 and function 704 (in a log scale).

As also will be appreciated by one skilled in the art, the embodiments may be embodied in various forms. Accordingly, the embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer-readable medium may be utilized including hard disks, CD-ROMs, digital versatile discs (DVD), optical storage devices, or magnetic storage devices such a floppy disk or magnetic tape. Other non-limiting examples of computer-readable media include flash-type memories or other known types of memories.

The disclosed exemplary embodiments provide an apparatus and a method for seismic data de-noising. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for de-noising seismic data recorded with seismic receivers, the method comprising:
transforming the seismic data into a Tau-P domain to generate transformed seismic data traces;
scaling the transformed seismic data traces using a semblance value to generate scaled seismic data traces;
selecting a scaled seismic data trace having a maximum energy; and
removing the selected, scaled seismic data trace from the seismic data to generate de-noised seismic data.

2. The method of claim 1, wherein the step of transforming further comprises
calculating:
D(p, τ)=∫d(x, τ−p*x)dx
where D (p,τ) is the transformed, seismic trace in the Tau-P domain;
p is a slowness value; and
τ is a time intercept value.

3. The method of claim 1, further comprising the step of:
determining the semblance value by calculating:
$$s ( ρ , τ ) = \frac{{\sum }_{i = 1}^{N} {d ( {x}_{i} , τ - p * {x}_{i} )}^{2}}{N {\sum }_{i = 1}^{N} {d}^{2} ( xi , τ - p * xi )}$$
where s (p,τ) is a semblance of a seismic trace in the Tau-P domain;
p is a slowness value;
τ is a time intercept value; and
i is a power index.

4. The method of claim 3, wherein the step of scaling further comprises:
multiplying each of the transformed seismic data traces with the semblance value.

5. The method of claim 1, further comprising:
reverse transforming the de-noised seismic data to the time-space domain.

6. The method of claim 1, wherein the seismic data includes turn noise which is removed to generate the de-noised seismic data.

7. The method of claim 1, further comprising:
iterating the steps of transforming, scaling, selecting and removing until the de-noised seismic data satisfies a quality criterion.

8. The method of claim 7, wherein the quality criterion is that the semblance value is less than a threshold value.

9. The method of claim 7, wherein the quality criterion is that the de-noised seismic data is stable.

10. A computing device for de-noising seismic data recorded with seismic receivers, the computing device comprising:
an interface configured to receive the seismic data recorded with the seismic receivers, wherein the seismic data is recorded in a time-space domain; and
a processor connected to the interface and configured to implement a de-noising technique including:
transforming the seismic data from the time-space domain into a Tau-P domain to generate transformed seismic data traces;
scaling the transformed seismic data traces using a semblance value to generate scaled seismic data traces;
selecting a scaled seismic data trace having a maximum energy; and
removing the selected, scaled seismic data trace from the seismic data to generate de-noised seismic data.

11. The system of claim 10, wherein the processor performs the transformation by calculating:
D(p, τ)=∫d(x, τ−p*x)dx
where D (p, τ) is the transformed, seismic trace in the Tau-P domain;
p is a slowness value; and
τ is a time intercept value.

12. The system of claim 10, wherein the processor performs the determination of the semblance value by calculating:
$$s ( ρ , τ ) = \frac{{\sum }_{i = 1}^{N} {d ( {x}_{i} , τ - p * {x}_{i} )}^{2}}{N {\sum }_{i = 1}^{N} {d}^{2} ( xi , τ - p * xi )}$$
where s (p,τ) is a semblance of a seismic trace in the Tau-P domain;
p is a slowness value;
τ is a time intercept value; and
i is a power index.

13. The system of claim 12, wherein the wherein the processor performs the scaling by multiplying each of the transformed seismic data traces with the semblance value.

14. The system of claim 10, wherein the processor is further configured to reverse transform the de-noised seismic data to the time-space domain.

15. The system of claim 10, wherein the seismic data includes turn noise which is removed to generate the de-noised seismic data.

16. The system of claim 10, wherein the processor is further configured to iterate the steps of transforming, scaling, selecting and removing until the de-noised seismic data satisfies a quality criterion.

17. The system of claim 16, wherein the quality criterion is that the semblance value is less than a threshold value.

18. The system of claim 16, wherein the quality criterion is that the de-noised seismic data is stable.

19. The method of claim 1, further comprising:
generating an image of a subsurface based on the de-noised seismic data.

20. The system of claim 10, further comprising:
an output device which generates an image of a subsurface based on the de-noised data.
